(19) United States
(12) Patent Application Publication
(10) Pub. No.: US 2015/0273933 A1
(43) Pub. Date: Oct. 1, 2015

(54) Interchangeable Decorative Components

(71) Applicant: Tira Meninga, Manteca, CA (US)

(72) Inventor: Tira Meninga, Manteca, CA (US)

(21) Appl. No.: 14/225,946

(22) Filed: Mar. 26, 2014

(51) Int. Cl. B44C 3/12

(52) U.S. Cl. CPC B44C 3/12

(57) ABSTRACT

A system of combining decorative ornaments with fasteners may comprise a topper assembly, magnets aligned in series and a lower fastener system. A topper assembly or decorative ornament may comprise one or more cloth flowers or other ornaments that sandwich or encase a magnet. A plurality of decorative ornaments may be magnetically aligned in series such that each north end is next to a south end. The most bottom portion of a decorative ornament or series of decorative ornaments may comprise a lower faster, with the fastener comprising a ferrous section so as to attract the adjacent magnet. The artful use of magnets in series allows for decorative ornaments to be well secured, but yet facilitate toolless exchanges of decorative ornaments such that a consumer needs only one lower fastener.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates to interchangeable decorative components. More particularly, the invention relates to means and methods of magnetically securing open ended combinations of decorative elements.

(2) Description of the Related Art

U.S. Patent Application with Publication Number 2012/0234042 by Chase et al discloses a sandal having an attachment system for retaining a decorative item on top of a sandal. The Chase disclosure fails to enable easily interchangeable decorative items. The attachment systems of Chase are unduly complex.

### BRIEF SUMMARY OF THE INVENTION

The present invention overcomes shortfalls in the related art by presenting an unobvious and unique combination, configuration and use of magnets, clips and other mechanical attachments and ornaments. The known related art fails to disclose, suggest or teach the use or construction of the disclosed embodiments.

Disclosed embodiments may include the use of a topper sometimes comprised of an integrated magnet, the integrated magnet disposed in a north south orientation to facilitate in series attraction and retention with other components.

Disclosed embodiments may include the use and construction of one or more base ornaments having magnets internally disposed in a north south configuration suitable for series attraction and retention with other components.

Disclosed embodiments may include the use of lower assemblies, which may comprise clips, mechanical attachments or magnetic components.

Disclosed embodiments overcome shortfalls in the art by facilitating kit systems wherein items of fashion may be quickly interchanged to accommodate different fashion needs. Disclosed embodiments provide economic advantages as an unlimited number of fashion accessories may be mated to one underlying fastening system, thus saving the expense of manufacturing multiple fastening systems.

The use of magnets and ferrous components in series solves long felt problems in the art by increasing magnetic attachment properties as the number of worn accessory components increase. Disclosed embodiments overcome shortfalls in the art by use of adhesive pieces having a larger radius as compared to the radius of an integrated or secured magnet.

### BRIEF DESCRIPTION OF THE DRAWINGS

FIG. 1 is an exploded view of a disclosed assembly

FIG. 2 depicts various disclosed components

FIG. 3 depicts a disclosed topper component prior to assembly

FIG. 4 depicts a disclosed topper component prior to assembly

FIG. 5 depicts a disclosed ornament system prior to assembly

### REFERENCE NUMERALS IN THE DRAWINGS

100 a upper or superior cloth flower

110 a lower or inferior cloth flower pedal

150 a center axis of attachment or alignment

200 a magnet

210 a north side or orientation of a magnet 200

220 a south side or orientation of a magnet 200

230 radius of a magnet 200

300 adhesive piece or other means of frictional attachment

310 top side of adhesive piece 300

320 bottom side of adhesive piece 300

330 radius of an adhesive piece 300

350 cloth, bottom cloth or other material base sometimes used to cover the bottom side of an adhesive component 300

355 a radius of the cloth 350 or other material

400 a fully assembled ornament

500 a base clip comprising a hair band

510 a ferrous portion of a hair band 500

520 a base clip comprising a pin and plate

525 a stick pin or other means of attachment found upon a pin and plate system 520

530 a ferrous portion of a pin and plate base clip

540 a base clip comprising a pinch clip

550 a ferrous portion of a pinch clip

600 a jewel or other component with a top finish

610 a finished surface or a jewel or other top component

650 a jeweled flower

660 a jeweled flower with a magnet internally attached

670 a first decorative component with an integrated magnet

672 pedals of a first decorative component 670

675 a center section of a first decorative component 670

680 a second decorative component with an integrated magnet

682 pedals of a second decorative component 680

685 a center section of a second decorative component 680

700 a person

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

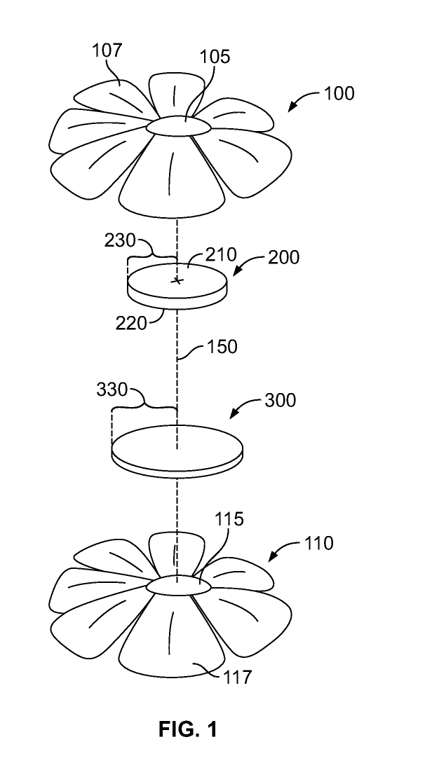

FIG. 1 depicts a disclosed embodiment comprising two cloth flower pedals comprising an upper cloth flower pedal 100 and a lower flower pedal 110, the two flower pedals enclosing or integrating a magnet 200 and an adhesive 300 or other means of attachment. The magnet 200 may comprise a north side 210 and a south side 220. The north and south sides are interchangeable and are referenced herein for purposes of illustrating a series orientation of the magnetic and/or ferrous components described herein.

The adhesive component 300 may comprise a cloth like material, disc form or other form, such that the magnet 200 is secured to the top cloth flower pedal 100 and the bottom flower pedal 110 is also attached. A mechanical advantage is achieved by use of an adhesive component 300 having a larger radius 330 as compared to the radius 230 of the magnet 200. The larger radius of the adhesive component 300 assists in encapsulating the magnet 300 between the top flower pedal 100 and the bottom flower pedal 110.

An upper flower pedal 100 may comprise a plurality of pedals 107 and a center section 105. The center section 105 may be used to align, encapsulate or otherwise secure a magnet 200. A lower flower pedal 110 may comprise a plurality of pedals 117 and a center section 115. The center section 117 may be used to align, encapsulate or otherwise secure a magnet 200. The center sections or center voids of the upper or lower flowers may be defined by the proximal ends of the pedals.

FIG. 1 also depicts the radius 330 of the adhesive disc or adhesive piece as being larger than the radius 230 of the magnet.

FIG. 1 depicts an exploded view or expanded view of a basic assembly of a single ornament. The upper flower pedal 100 and lower flower pedal 110 may take the form of a multitude of designs and materials.

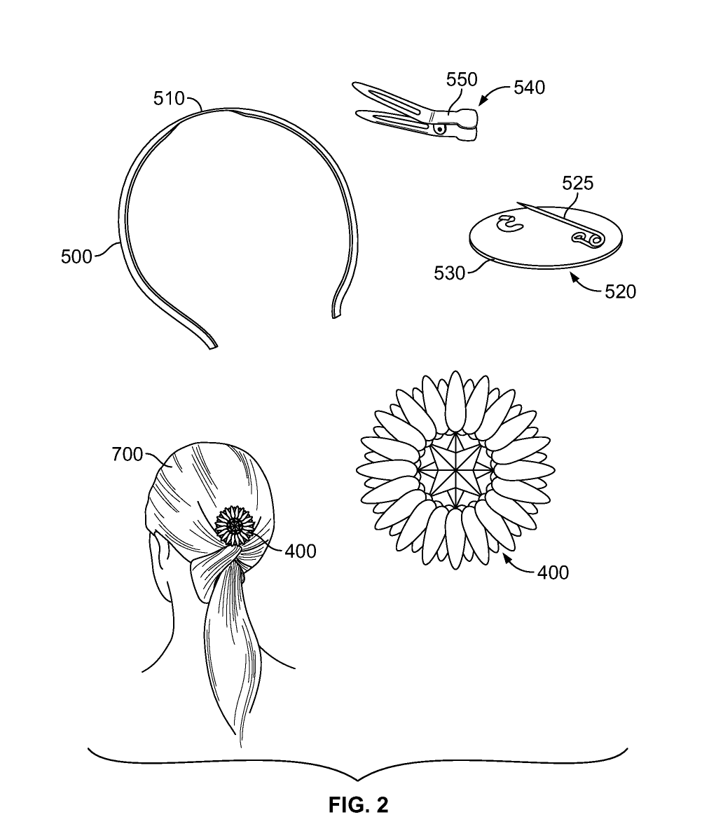

FIG. 2 depicts a completed or fully assembled ornament 400 shown alone and shown in use by a person 700. A plethora of base components or base clips are contemplated, FIG. 2 further depicts a hair band 500 comprising a ferrous portion 510. The ferrous portion or component on the hair band or any base clip may be used by a magnet to attach an ornament.

FIG. 2 further depicts pinch clip 540 comprising a ferrous portion, section or component 550. A pin and plate system 520 comprises a stick pin 525 and a ferrous portion 530. A plethora of base clips are contemplated. In general, a base clip is any implement having a ferrous portion and having means of attachment to a person, clothing or free standing display.

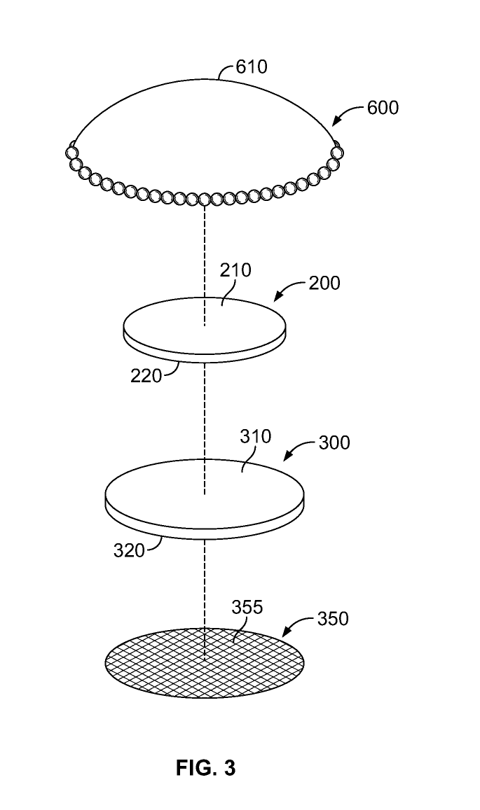

FIG. 3 depicts an assembly to construct a topper or a finishing top to an ornament. A topper or finished top has a finished or smooth top and a magnet 200 integrated into a lower recess. The magnet may nest within the topper or finished top.

FIG. 3 depicts a jewel 600 or other component with a top finish or finished surface 610. A magnet 200 may be fitted into a lower recess of the jewel 600 and further secured by use of an adhesive piece 300. The top side 310 of the adhesive piece may be secured to the bottom portion 220 of the magnet. The bottom portion 320 of the adhesive piece may be secured to the cloth 350 or material base.

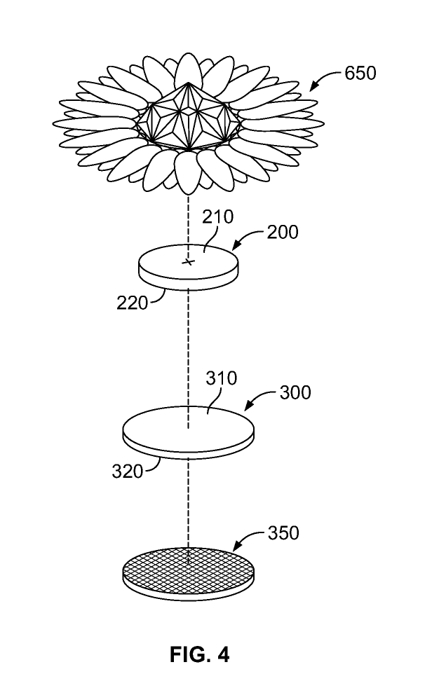

FIG. 4 depicts a variation of FIG. 3. In FIG. 4 a jeweled flower 650 accepts a magnet 200. The magnet 200 may be attached to an adhesive 300 and the adhesive may be covered by a cloth or other material base 350.

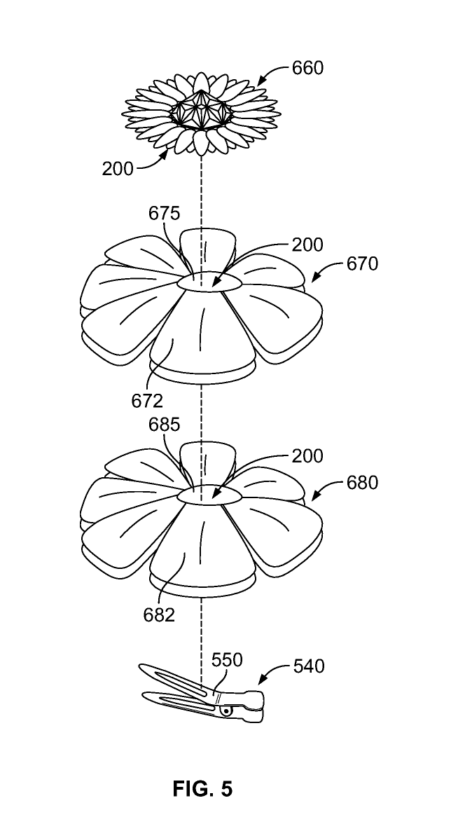

FIG. 5 depicts an exploded view or an expanded view of a system comprising a jeweled flower 660 with a magnet 200 internally integrated or attached, a first decorative component 670 with an internally integrated magnet 200, a second decorative component 680 with an internally integrated magnet 200 and a pinch clip 540 with the pinch clip comprising a ferrous portion 550. The magnets are aligned in series, such that a north side of one magnet is adjacent to a south side of an adjoining magnet.

Not all component combinations or all contemplated decorative attributes are shown in the drawings herein. The disclosed embodiments and spirit of the embodiments provide and enable an essentially limitless combination of interchangeable decorative components of numerous materials, shapes, sizes and colors. The components may be secured, attached or otherwise held together by magnets or other means. Each component may have a magnet permanently or temporarily attached or integrated. Each component may attach to another component and/or may attach to a base clip. A base clip may take the form of any attachment system and may comprise a hair band 500, pin and plate system 520, pinch clip 540 or other system. A base clip may comprise a ferrous portion or have attributes allowing for magnetic attraction or attachment to a decorative component. Disclosed embodiments and contemplated embodiments may be attached to hair, clothing, shoes and other items or may be used as standalone decorations.

The disclosed use of magnets in series overcomes shortfalls in the art as multiple magnets in series provide a magnetic attraction stronger than one magnet.

Disclosed embodiments overcome shortfalls in the art by enabling an interchangeable and variable decorative ornament system. Separate ornaments of various styles, appearances, colors and textures may be quickly and easily mixed and matched and otherwise attached to a lower fastener such as a base clip. Thus, numerous ornaments may be fastened to a lower fastener and a consumer need purchase only one lower fastener.

Disclosed embodiments overcome shortfalls in the art by enabling a system wherein a magnet may be artfully integrated into an ornament. The use of an adhesive piece 300 having a radius 330 larger than the radius of an adjacent magnet provides advantages of visually hiding the magnet and attaching an upper flower 100 to a lower flower 110. The excess radius of the adhesive spans past the magnet, allowing the outer portions of the radius to come into contact with upper and lower ornament members. Thus, disclosed embodiments overcome shortfalls in the art by providing new efficiencies and economies in manufacturing.

Disclosed embodiments include, but are not limited to the items described below:

Items.

Item 1. A system of interchangeable decorative ornaments with a lower fastener, the system comprising:

a) an interchangeable ornament comprising a top member and a bottom member;

b) a magnet having a north side and a south side, the magnet 200 having a radius 230;

c) a disk shaped adhesive piece 300 having a radius 330 larger than the radius 230 of the magnet 200;

d) an inner radius portion of the disk shaped adhesive piece attached to a bottom side of the magnet;

e) an outer portion of the disk shaped adhesive piece attached to the top member and the bottom member; and

f) a lower fastener comprising a mechanical attachment and a ferrous portion, the ferrous portion in magnetic attachment with the magnet.

Item 2. The system of item 1 further comprising a plurality of topper components, each topper component comprising:

a) a decoration 600 having a top finish 610;

b) a magnet 200 having a north 210, a south end 220 and radius 230;

c) a disked shaped adhesive piece 300 having a bottom side 320, top side 310 and a radius 330, the radius of greater length as compared to the radius 230 of the magnet 200. An adhesive piece that joins disclosed components, the adhesive piece having no specific size or shape, and the configuration, composition and attributes of the adhesive piece not limited by the drawings or other descriptions herein.

d) a bottom cloth 350 having a radius 355 substantially similar in length as compared to the radius 330 of the disked shaped adhesive piece 300;

e) the bottom cloth 350 adhesively attached to the bottom portion of the disked shaped adhesive piece, an inner area of the bottom surface of the magnet adhesively attached to the top side of the disked shaped adhesive piece and an outer radial portion of the disked shaped adhesive piece adhesively attached to a bottom section of the decoration 600.

Item 3. The system of item 2 further comprising a plurality of lower fasteners, the lower fasters selected from the group comprising: a pinch clip 540, pin and plate 520, hair band.

Item 4. The system of item 3 further comprising a plurality of topper components magnetically attached to each other in series.

Item 5. The system of item 4 wherein the plurality of topper components are magnetically attached to bottom fastener.

Item 6. The system of item 4 further comprising a plurality of topper components magnetically attached in a free standing system.

What is claimed is:

1. A system of interchangeable decorative ornaments with a lower fastener, the system comprising:
a) an interchangeable ornament comprising a top member and a bottom member;
b) a magnet having a north side and a south side, the magnet having a radius;
c) an adhesive piece;
d) an inner portion of the adhesive piece attached to a bottom side of the magnet;
e) an outer portion of the adhesive piece attached to the top member and the bottom member of the interchangeable ornament; and
f) a lower fastener comprising a mechanical attachment and a ferrous portion, the ferrous portion in magnetic attachment with the magnet.

2. The system of claim 1 further comprising a plurality of topper components, each topper component comprising:
a) a decoration having a top finish;
b) a magnet having a north end, a south end and radius;
c) a bottom cloth having a radius substantially similar in length as compared to the radius of the adhesive piece;
d) the bottom cloth adhesively attached to the bottom portion of the adhesive piece, an inner area of the bottom surface of the magnet adhesively attached to the top side of the adhesive piece and an outer radial portion of the adhesive piece adhesively attached to a bottom section of the decoration.

3. The system of claim 2 further comprising a plurality of lower fasteners, the lower fasters selected from the group comprising: a pinch clip, pin and plate and hair band.

4. The system of claim 3 further comprising a plurality of topper components magnetically attached to each other in series.

5. The system of claim 4 wherein the plurality of topper components are magnetically attached to a bottom fastener.

6. The system of claim 4 further comprising a plurality of topper components magnetically attached in a free standing system.
